(19) United States
(12) Patent Application Publication
(10) Pub. No.: US 2019/0188799 A1
(43) Pub. Date: Jun. 20, 2019

(54) SYSTEM AND METHOD FOR MANAGING RISKS AND REDUCING COSTS FOR INSURANCE COMPANIES

(71) Applicant: Cognizant Technology Solutions India Pvt. Ltd, Chennai (IN)

(72) Inventors: Yogeshwar Kumar, Deoghar (IN); Arvind Viswanathan, Vadodara (IN); Prem Srinivas Sriram, Chennai (IN)

(21) Appl. No.: 15/895,160

(22) Filed: Feb. 13, 2018

(30) Foreign Application Priority Data
Dec. 14, 2017 (IN) 201741044931

(51) Int. Cl. G06Q 40/08

(52) U.S. Cl. CPC G06Q 40/08

(57) ABSTRACT

A system and computer-implemented method for managing risks and reducing costs for insurance companies is provided. The system comprises a customer portal to create a profile corresponding to each of one or more customers. The system further comprises a member management module to compute an individual score corresponding to each of the one or more customers, associate each of the one or more customers with one or more pre-defined groups, monitor activities of the one or more customers and update the computed individual score. Furthermore, the system comprises a group management module to update a pre-defined group score. The system also comprises an analytical engine configured to communicate with existing systems to facilitate computing insurance premium of each of the one or more customers based on at least one of: the corresponding updated individual score, the updated score of the one or more groups and the monitored activities.

### CROSS REFERENCE TO RELATED APPLICATION

This application is related to and claims the benefit of Indian Patent Application Number 201741044931 filed on Dec. 14, 2017, the contents of which are incorporated herein by reference in their entirety.

### FIELD OF THE INVENTION

The present invention relates generally to risk and cost management in insurance industry. More particularly, the present invention provides a system and method for efficiently managing risks and reducing costs for insurance companies.

### BACKGROUND OF THE INVENTION

Over the years, insurance industry has grown manifolds which has led to emergence of many new insurance companies. Emergence of so many insurance providers has led to an increase in customer acquisition, sales and marketing costs incurred by the insurance providers. Also nowadays, insurance providers are exposed to higher risks and frauds.

Conventionally, insurance providers employ various systems and methods for managing risks and costs. For example, insurance providers employ insurance agents that sell insurance policies to the customers. Also, the insurance providers conduct various checks and examinations such as background checks, medical examination, surveying and physical examination before issuing insurance policies. However, the existing systems and methods used by the insurance companies suffer from various disadvantages. The costs for customer acquisition, sales and marketing are still quite high. The existing systems and methods are incapable of efficiently reducing risks and risk distribution. Further, the existing systems and methods are unable to easily and seamlessly acquire new customers. Also, the existing systems and methods do not utilize analytics, risk-reward models along with peer-to-peer referrals, gamification and social media profiles for managing risk and reducing costs.

In light of the above-mentioned disadvantages, there is a need for a system and method for managing risks and reducing costs by grouping trusted insurance customers. Further, there is a need for s system and method that provides an omni-channel platform for customers and insurance providers to collaborate. Furthermore, there is a need for a system and method that leverages social media profiles of existing customers and analytics to identify and acquire new customers and target advertising for focus groups. In addition, there is a need for a system and method that is capable of creating groups of trusted members that inculcates moral binding by using risk-reward model.

### SUMMARY OF THE INVENTION

A system, computer-implemented method and computer program product for managing risks and reducing costs for insurance companies is provided. The system comprises a customer portal configured to create a profile corresponding to each of one or more customers of one or more insurance companies. The system further comprises a member management module configured to compute an individual score corresponding to each of the one or more customers, associate each of the one or more customers with one or more pre-defined groups of customers, monitor activities of each of the one or more customers and update the computed individual score of each of the one or more customers based on the monitored activities. Furthermore, the system comprises a group management module configured to update a pre-defined group score based on the monitored activities and the updated individual score of each of the one or more customers associated with the group. The system also comprises an analytical engine configured to communicate with one or more existing systems to facilitate computing insurance premium of each of the one or more customers based on at least one of: the corresponding updated individual score, the updated score of the one or more groups corresponding to each of the one or more customers and the monitored activities of the one or more customers.

In an embodiment of the present invention, the profile corresponding to each of the one or more customers is created by the one or more customers using existing accounts on one or more social media websites. In an embodiment of the present invention, the profile corresponding to each of the one or more customers is created by the one or more customers by providing details comprising primary email address, secondary email address, new password, name, phone number, policy number, address and date of birth. In an embodiment of the present invention, the individual score corresponding to each of the one or more customers is computed based on the created customer profile and one or more parameters. Further, the one or more parameters for computing individual score comprise number of referrals in low, medium and high risk categories, total number of referrals, frequency of referrals, referral fitment, number of claims, number of frauds, number of reported fraudulent activities and number of policy enrolments by a customer.

In an embodiment of the present invention, the one or more customers are associated with one or more pre-defined groups based on one or more criteria comprising demographic factors, type of insurance product and risk profile of customer. In an embodiment of the present invention, the monitored activities of each of the one or more customers comprise number of referrals in low, medium and high risk categories, frequency of referrals, referral fitment, number of claims, number of frauds, number of reported fraudulent activities and number of policy enrolments. In an embodiment of the present invention, the system further comprises a social media interface module configured to facilitate the one or more customers to view one or more profiles of possible connections present on one or more social media websites and create one or more trusted groups. The system further comprises a risk profiling module configured to generate a risk score for the one or more profiles of the possible connections present on the one or more social media websites.

The computer-implemented method for managing risks and reducing costs for insurance companies, via program instructions stored in a memory and executed by a processor, comprises creating a profile corresponding to each of one or more customers of one or more insurance companies. The computer-implemented method further comprises computing an individual score corresponding to each of the one or more customers. Furthermore, the computer-implemented method comprises associating each of the one or more customers with one or more pre-defined groups of customers. The computer-implemented method also comprises monitoring activities of each of the one or more customers. The computer-implemented method further comprises updating the computed individual score of each of the one or more customers based on the monitored activities. Furthermore, the computer-implemented method comprises updating a pre-defined group score based on the monitored activities and the updated individual score of each of the one or more customers associated with the group. The computer-implemented method also comprises facilitating one or more existing systems to compute insurance premium of each of the one or more customers based on at least one of: the corresponding updated individual score, the updated score of the one or more groups corresponding to each of the one or more customers and the monitored activities of the one or more customers.

The computer program product for managing risks and reducing costs for insurance companies comprising a non-transitory computer-readable medium having computer-readable program code stored thereon, the computer-readable program code comprising instructions that when executed by a processor, cause the processor to create a profile corresponding to each of one or more customers of one or more insurance companies. The processor further configured to compute an individual score corresponding to each of the one or more customers. Furthermore, the processor configured to associate each of the one or more customers with one or more pre-defined groups of customers. The processor also configured to monitor activities of each of the one or more customers. The processor further configured to update the computed individual score of each of the one or more customers based on the monitored activities. Furthermore, the processor configured to update a pre-defined group score based on the monitored activities and the updated individual score of each of the one or more customers associated with the group. The processor also configured to facilitate one or more existing systems to compute insurance premium of each of the one or more customers based on at least one of: the corresponding updated individual score, the updated score of the one or more groups corresponding to each of the one or more customers and the monitored activities of the one or more customers.

### BRIEF DESCRIPTION OF THE ACCOMPANYING DRAWINGS

The present invention is described by way of embodiments illustrated in the accompanying drawings wherein:

FIG. 1 is a block diagram illustrating a system for managing risks and reducing costs for insurance companies, in accordance with an embodiment of the present invention;

FIG. 1A is an exemplary screenshot of customer portal for inviting new individuals, in accordance with an embodiment of the present invention;

FIG. 1B is an exemplary screenshot illustrating generation of risk score by providing details related to a referral, in accordance with an exemplary embodiment of the present invention;

FIG. 2 is a flowchart illustrating a method for managing risks and reducing costs for insurance companies, in accordance with an embodiment of the present invention; and

FIG. 3 illustrates an exemplary computer system for managing risks and reducing costs for insurance companies, in accordance with an embodiment of the present invention.

### DETAILED DESCRIPTION OF THE INVENTION

A system and method for managing risks and reducing costs for insurance companies is described herein. The invention provides for a system and method that provides an omni-channel platform for customers and insurance providers to collaborate. The invention further provides for a system and method that is capable of creating groups of trusted members and reduces risks by using risk-reward models and gamification. Furthermore, the invention provides for a system and method that leverages social media profiles of existing customers and analytics to identify and acquire new customers and targeted advertising for focus groups.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

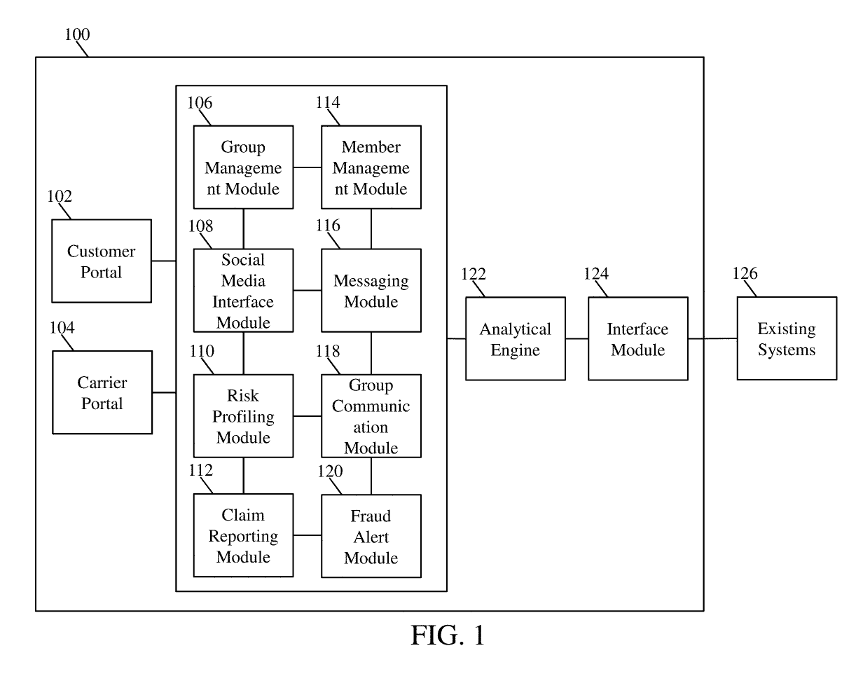

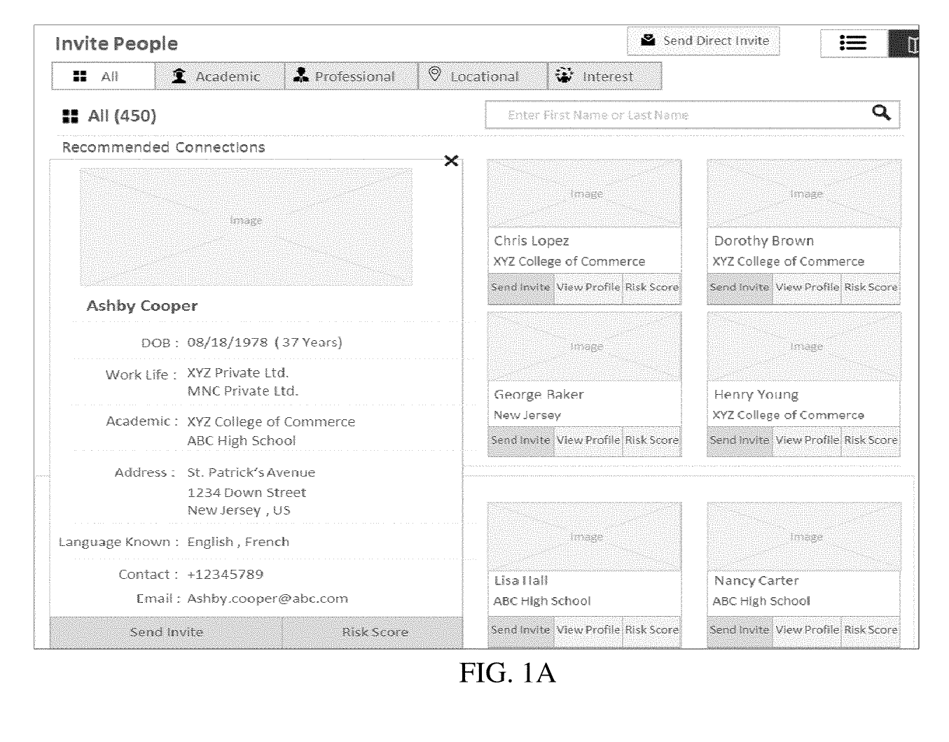

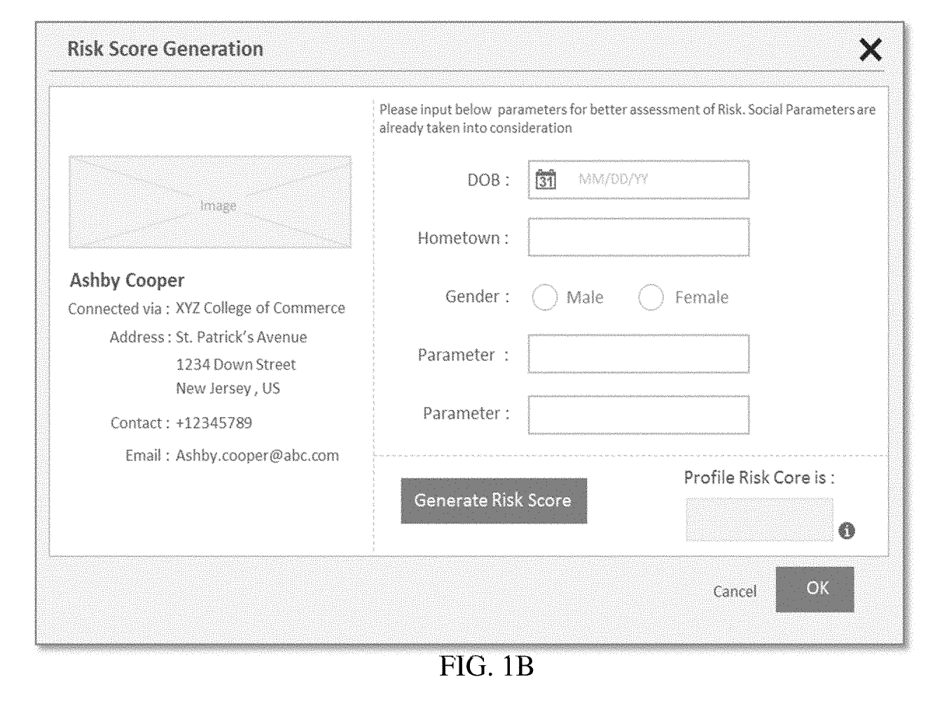

FIG. 1 is a block diagram illustrating a system 100 for managing risks and reducing costs for insurance companies, in accordance with an embodiment of the present invention.

The system 100 comprises a customer portal 102, a carrier portal 104, a group management module 106, a social media interface module 108, a risk profiling module 110, a claim reporting module 112, a member management module 114, a messaging module 116, a group communication module 118, a fraud alert module 120, an analytical engine and an interface module 124. The interface module 124 facilitates connection with one or more existing systems 126.

The customer portal 102 is a front end user interface accessed by one or more customers of one or more insurance companies. Further, the one or more customers access the customer portal 102 via one or more electronic communication devices. In the embodiment of the present invention, the one or more electronic communication devices include, but not limited to, desktops, mobile phones, laptops, tablets and any other electronic communication device. On becoming a customer of the one or more insurance companies, the one or more customers access their profiles via the customer portal 102 using the one or more electronic communication devices.

In an embodiment of the present invention, the customer portal 102 is accessible by existing customers as well as new customers. Further, the customer portal 102 is configured to create profiles corresponding to each of the one or more customers of the one or more insurance companies. In an embodiment of the present invention, profiles of the one or more customers are created automatically when they buy an insurance product from the one or more companies. In another embodiment of the present invention, the customer portal 102 provides options for creating a customer profile by prompting new customers to provide details such as, but not limited to, primary email address, secondary email address, new password, name, phone number, policy number, date of birth and address for profile creation. In an embodiment of the present invention, the customer portal 102 provides options to the one or more customers to create a new customer profile using existing accounts on one or more social media websites such as, but not limited to, Facebook, Google+ and LinkedIn. The existing customers may access their profiles via the customer portal 102 by providing authentication details including, but not limited to, login identification and password provided at the time of registration and creation of a customer profile. Further, the customer portal 102 provides one or more options for, but not limited to, viewing, editing and managing profile, friends list, friends profiles, recent conversations, discussion threads within the one or more groups, insurance company details, list of frequently used dashboards, settings, group dashboards and alerts and notification related to, but not limited to, premiums, groups, group claims and new connections.

In an embodiment of the present invention, the group dashboard provides options to view information related to the one or more groups to which the customer accessing the customer portal 102 is a member of. Further, the information corresponding to the one or more groups include, but not limited to, unique group identification, name, number of members, list of newly added members, added members history, claim history, group fund utilization history, frauds history, group score, customer's share of group fund, group comparison dashboards displaying group's performance against other groups and a list of all other groups and corresponding group scores.

In an embodiment of the present invention, the customer portal 102 provides options to search other individuals. The one or more customers may search based on a criterion and/or by applying filters based on, but not limited to, name, college, workplace and city. In an embodiment of the present invention, the one or more customers may invite other individuals to join their groups. The customer portal 102 also provides options for, but not limited to, viewing profiles and generating real-time risk score of the other individuals prior to sending invitation and assessing impact on their group score on addition of the individuals to the group. In an embodiment of the present invention, the customer portal 102 facilitates the one or more customers to generate a risk score and report in real-time for individuals that do not have a social profile. The system 100 facilitates in pulling information related to the individuals to be added from one or more social media platforms and renders the information on the customer portal 102 for the one or more customers. The information related to other individuals includes, but not limited to, age, hometown, place of current residence, university and gender. FIG. 1A is an exemplary screenshot of the customer portal 102 for inviting new individuals, in accordance with an embodiment of the present invention.

In an embodiment of the present invention, the one or more customers initiate real-time communication with other members and persons they wish to invite. In case, the other members and individuals are not online, then the one or more customers may send offline messages that can be notified to the other members and individuals by sending alerts. The one or more customers may also recommend addition of the one or more individuals that do not have a profile to the one or more insurance companies via the customer portal 102. Further, the one or more customers may provide a trust weightage score of the one or more persons to the one or more insurance companies. The customer portal 102 provides additional options to the one or more customers for addition of persons that do not have profiles on any social media platforms by manually adding their details and generating a risk score rating using the added details.

In an embodiment of the present invention, the one or more users can view a list of all the claims raised by the members of the same group via the customer portal 102. The one or more users can also view details related to claims such as, but not limited to, claim identification, claim amount, claim amount approver's name, claim applied date, claim approved date and claim status. The one or more customers can also use search functionality to search for specific claims by applying one or more search parameters. The one or more customers can view claim details and notify the one or more insurance companies in case of fraudulent claims by the one or more members of the group. The one or more members can also view past claims and corresponding claim details, raise a new claim, view premium details, past premiums, premium bonus, referrals and referral bonus. In an embodiment of the present invention, the customer portal 102 facilitates access to insurance company's existing system 126 in case the one or more customers select an option to pay their premium. In an embodiment of the present invention, the customer portal 102 also provides one or more options to the one or more customers to view discussion threads, view past comments and initiate new discussion threads.

The carrier portal 104 is a front end user interface accessed by one or more employees of the one or more insurance companies. The one or more employees of the one or more insurance companies include, but not limited to, administrators, insurance agents and sales and marketing team members. The carrier portal 104 provides access to various screens such as, but not limited to, home screen, approvals screen, groups details screen, group details edit screen, group risk settings screen, pending claims screen, approving/rejecting pending claims screen, claims history screen, channel conversion by region screen and past frauds screen that provide various options to the one or more employees of the one or more insurance companies. The one or more employees of the one or more insurance companies have options to view drill-downed details within the various screens.

In an embodiment of the present invention, the carrier portal 104 provides options such as, but not limited to, viewing list of pending claims, viewing member additions, viewing member removals, viewing member exits, acknowledging, approving and rejecting claims and reported frauds, viewing past approvals, viewing group statistics, viewing group details, editing group details, viewing and editing group risk settings, searching and viewing pending claims, approving and rejecting pending claims, viewing revenue statistics, viewing fraud claim instances by month, date and year and viewing percentage change in frauds.

In an embodiment of the present invention, the one or more employees are provided options via the carrier portal 104 to modify group score and customers' individual score, set rules and settings that influence computation of individual scores, group scores and risk scores and offer bonuses and premium discounts to the one or more customers.

The group management module 106 facilitates in creating, managing and modifying the one or more groups. The group management module 106 facilitates in providing options related to groups on the customer portal 102 and the carrier portal 104. The group management module 106, in collaboration with the member management module 114, facilitates formation of one or more groups and associating the one or more customers with the one or more groups based on various criteria such as, but not limited to, demographic factors, type of insurance product and risk profile of the customers. In an embodiment of the present invention, each group has a group score which is a function of all the members' individual scores, group members' behavior and other group parameters such as, but not limited to, number of members, rate of increase of trusted members and the likes. The group management 106 module further provides gamification functionalities such as, but not limited to, leaderboards, score alerts and group score aggregators. The gamification functionalities are applicable amongst the members within a group as well as amongst the groups. In case a member exits the group by virtue of either being willful exit or forceful termination, the exited member's referrals are marked as ready for adoption by other member of the same group. If no one adopts the one or more exited member's referrals, then those exited member referrals remain in an “orphans” list within the group.

The social media interface module 108 facilitates connecting the system 100 with the one or more social media platforms and websites. The social media interface module 108 validates authentication details provided by the one or more customers to access and pull information from the social media profile of the one or more customers and their connections. In an embodiment of the present invention, the social media interface module 108 is configured to facilitate the one or more customers to view one or more profiles of possible connections present on the one or more social media websites and create one or more trusted groups.

The risk profiling module 110 generates risk profiles and the risk score of the one or more customers. The risk profiling module 110 enables the one or more customers to generate base risk scores of the individuals prior to sending them invitations for joining a group. The risk profiling module 110 comprises a risk profile generation algorithm which considers various factors including, but not limited to, demographic factors and qualitative factors related to the one or more individuals. In an embodiment of the present invention, the demographic factors and the qualitative factors are sourced automatically from social feeds and through offline information provided by the one or more customers. The demographic factors include, but not limited to, age, location, gender, marital status, school and college. The qualitative factors include, but not limited to, risk taking tendency, smoking habits, spending habits and rule and law obedience tendency. In an embodiment of the present invention, the factors considered for risk score and risk profile generation are based on the insurance company preferences and type of insurance product. Further, the factors are customizable and may be modified by the insurance company via the carrier portal 104. Furthermore, weightage for each factor is also configured by the insurance company based on specific parameters such as targeted customer segment.

In an embodiment of the present invention, the risk profile generation algorithm facilitates in providing risk profile and risk score of individuals that act as a guide to the one or more customers prior to sending invitation and recommending the individuals to the insurance company.

In an embodiment of the present invention, the risk profiling module 110 is also configured to generate a risk score for the one or more profiles of the possible connections present on the one or more social media websites. In an embodiment of the present invention, the risk score is generated for the one or more profiles of the possible connections on the one or more social media websites prior to addition to the one or more created trusted groups.

In an embodiment of the present invention, the output of the risk profile generation algorithm includes, but not limited to, a risk score, a risk grade, a risk percentage and a detailed report containing qualitative analysis and list of considered factors and weightages. In an embodiment of the present invention, the one or more customers are displayed messages associated with qualitative analysis such as, but not limited to, prone to high risk and prone to medium degree of violation of rules such as, but not limited to, traffic rules. At the time of adding the individual to the group, the one or more customers may use the risk report and/or offline analysis for updating the level of trust percentage that the one or more customers may have upon the individual to be added. Based upon the trust percentage, the risk and reward points are computed. The value of trust percentage may be changed in the future by the one or more customers with some preset business rules fixed by the insurance company. The one or more customers also have an option to define the trust percentage via the customer portal 102. Further, the one or more employees can define the business rules for the trust setting percentage via the carrier portal 104.

FIG. 1B is an exemplary screenshot illustrating generation of risk score by providing details related to a referral, in accordance with an exemplary embodiment of the present invention.

The claim reporting module 112 is configured to generate a list of all the claims, current and past, submitted by the members of one or more groups. Within a group, all the claims are visible to the members of the group. In an embodiment of the present invention, the confidential information pertaining to the claims is suitably masked prior to being made public within the group. Each member of the group has the discretion to mark/post any claim as suspicious or fraud along with reasons. Further, on receiving such claims, the insurance company may carry out investigation and take suitable actions on the claims.

The member management module 114 is configured to facilitate creating and managing profiles of the one or more customers of the insurance companies. The member management module 114 support functionalities provided by the customer portal 102. The member management module 114 also acts as a repository and stores details related to the one or more customers and corresponding groups. The member management module 114 provides options to each member for viewing individual dashboard comprising his individual score, risk rating, claims history, premiums trend and policies information. In an embodiment of the present invention, each member is equal in the group in terms of hierarchy. There is no group leader or lead member. Further, each member can add any person to the group. Furthermore, each member has the right to report abuse for any claim raised by other members in the group. A member can also be removed from the group for any fraudulent activity under the defined business rules of the insurance company.

In an embodiment of the present invention, the member management module 114 facilitates computing the individual score corresponding to each of the one or more customers. In an embodiment of the present invention, the individual score corresponding to each of the one or more customers is computed based on the created customer profile and one or more parameters. Further, the member management module 114 associates each of the one or more customers with one or more pre-defined groups of customers. Furthermore, the member management module 114 monitors activities of each of the one or more customers and updates the computed individual score of each of the one or more customers based on the monitored activities. In an embodiment of the present invention, the monitored activities of each of the one or more customers comprise number of referrals in low, medium and high risk categories, frequency of referrals, referral fitment, number of claims, number of frauds, number of reported fraudulent activities and number of policy enrolments. The member management module 114 also communicates with the group management module 106 which then updates the pre-defined group score of the one or more groups based on the monitored activities and the updated individual score of each of the one or more customers associated with the group.

The messaging module 116 facilitates the one or more customers to communicate with other customers and individuals via social media platforms and one or more communication channels. In an embodiment of the present invention, the messaging module 116 provides functionalities for, but not limited to, instant messaging and offline messaging. The messaging module 116 further facilitates sending alerts and notifications related to, but not limited to, premiums, renewals, workflow changes, new member additions and new claims to the one or more customers via one or more communication channels. The one or more communication channels include, but not limited to, electronic mail, Short messaging Service (SMS), existing instant messengers and facsimile. In case of new members' addition who are not found on social media and are added through offline mechanism, an email is sent to the prospect with instructions on registering with the system 100.

The group communication module 118 is configured to facilitate communication between the one or more members of the one or more groups. The group communication module 118 also acts as a repository and stores discussion threads. The group communication module 118 further monitors activities in various discussion threads and facilitates sending alerts to the one or more members. In an embodiment of the present invention, the group communication module 118 provides options via the customer portal 102 to conduct polls for collective decision making.

The fraud alert module 120 is configured to provide options to the one or more customers and the one or more employees via the customer portal 102 and the carrier portal 104 respectively to manage, report and notify any fraudulent activities of the one or more customers. The fraud alert module 120 communicates with the messaging module 116 to send real-time alerts to relevant stakeholders. The fraud alert module 120 is also configured to communicate with the risk profiling module 110 and the member management module 114 to modify the risk profile, risk score and individual scores of the one or more customers and the group score based on any fraudulent activity reported and verified.

The analytical engine 122 is a processing module that coordinates and facilitates functioning of various components of the system 100. In an embodiment of the present invention, the analytical engine 122 suggests, to the one or more members, a list of people who might be known or associated with the one or more members or share common interests for inviting to the group. The analytical engine 122 also enables the one or more customers with options to view possible connections in the social media and aid in getting them started to build their trusted group. The analytical engine 122 further facilitates in generating the risk score for the profiles present on the social network. Furthermore, the analytical engine 122 facilitates in analyzing data from various sources to provide personalized features and benefits to a focused set of individuals. The analytical engine 122 is also configured to communicate with the one or more existing systems 126 to facilitate computing insurance premium of each of the one or more customers based on at least one of: the corresponding updated individual score, the updated score of the one or more groups corresponding to each of the one or more customers and the monitored activities of the one or more customers.

In an embodiment of the present invention, the analytical engine 122 uses one or more slice and dice algorithms for analyzing the data. In an embodiment of the present invention, the analytical engine 122 aids in creating a sociological map for the one or more insurance companies. The created sociological map helps in separating the one or more customers into separate risk zones and understanding the needs of the one or more customers/buyers thereby facilitating in up-sell and cross-sell of the products. The analytical 122 engine also facilitates strategic and transaction based segmentation and helps in utilizing the data to generate revelations of the behavior in the group. The analytical engine 122 further predicts the claim behavior statistics of the one or more customers as well as peer network and helps in identifying the risk behavior and claim prediction.

The interface module 124 facilitates in interfacing with the one or more existing systems 126. The one or more existing systems 126 include, but not limited to, systems of the one or more insurance companies such as, but not limited to, underwriting system, billing system, policy administration system, claims management system and fraud management system. The interface module 124 also provides plugins to connect with social media platforms and websites.

In an embodiment of the present invention, the system 100 facilitates collaboration between the one or more customers. The system 100 facilitates the one or more customers to refer other trustworthy persons via the customer portal 102 to create their profile and join existing groups. Further, adding a new member to an existing group improves the individual score of the referee customer and the referral is responsible to the referee for his actions. The overall score of the group is dynamically determined throughout the lifetime of the group by the score management algorithm that considers a multitude of parameters such as, but not limited to, number and frequency of referral additions, number of wrong or fraudulent claims, instances of claims, activity on social forums and number of voluntary/involuntary exits. In an embodiment of the present invention, the score management algorithm also dynamically manages the score of the one or more customers based on various parameters. In an embodiment of the present invention, each of one or more parameters used for dynamically managing score are calibrated by the one or more insurance companies.

In an embodiment of the present invention, for increasing the individual score the one or more parameters considered include, but not limited to, number of referrals in low, medium and high risk categories, total number of referrals, frequency of referrals, referral fitment, number of claims, number of frauds, number of reported fraudulent activities and number of policy enrollment by a customer and by group members. In an embodiment of the present invention, the score of individual customers and groups is decreased by considering parameters such as, but not limited to, number of wrong and fraudulently submitted claims by customers and group members and number of times wrong information was provided by customer and group members.

The system 100 facilitates peer-to-peer marketing and expansion of network through newly added customers of the insurance company and also facilitates in reducing fraudulent activities. The system 100 also comprise a risk-reward model that provides reward points to the one or more members in case of, but not limited to, new referrals and reporting of fraudulent activities and penalizes the referrer in case referral commits any fraudulent activity. The scoring of the members as well as the groups dynamically changes in accordance with the scoring algorithm based on performance and behavior of the members and the group as a whole. In an embodiment of the present invention, the group score and individual score of the one or more customers are linked with the existing insurance system and considered in computing premiums payable by the one or more customers.

In an exemplary embodiment, let us take an example of an insured A who is an existing policy holder with an insurance company Alpha. The insured A signs up by accessing the customer portal 102. After successfully signing up, A is assigned a base score by the member management module 114. The insured A then logs into the customer portal 102 and is provided one or more options to view his connections through a social map. The social map shows A's social profile along with his connections and the way they are connected with the insured A. He sees person B in the recommendations who is his colleague and a trusted friend. A checks out B's risk profile generated by the risk profiling module 110. Further, A generates a risk report using the customer portal 102. The generated risk report is based upon various business rules pertaining to customer demographics like age, location, occupation and the likes. Based upon the generated risk report and risk score, A recommends B to create a profile using the system 100. The insurance company Alpha is alerted via the carrier portal 104 that B has been invited and is then prompted to carry out the underwriting and other formalities for policy purchase. The insurance company further carries out background checks if required and adds B to A's groups. The score management algorithm then increases A's score due to successful referral. In a similar manner, A and B continue to invite more and more trusted people and their scores are dynamically increased which contributes towards a decrease in premium costs.

In an exemplary embodiment of the present invention, let us consider an established group in which newly added member B commits a fraud (for example, self-damage, higher claims and the likes) and raises a claim. C knows B and has information on whether the claim raised by B is fraudulent. C, via the customer portal, alerts the insurance company alpha by using an appropriate option for reporting fraudulent claims. The insurance company receives the alert, via the carrier portal 104 and verifies the report and undertakes necessary actions. Upon verification, C is rewarded using reward points and his score is also increased. Further, B's score is decreased. Also, A's score is reduced as B was referred by A. B is penalized because of the fraudulent act. Thus, each member of a group can become vigilante for the group and fraudulent and trust abuse activities are minimized using the system 100.

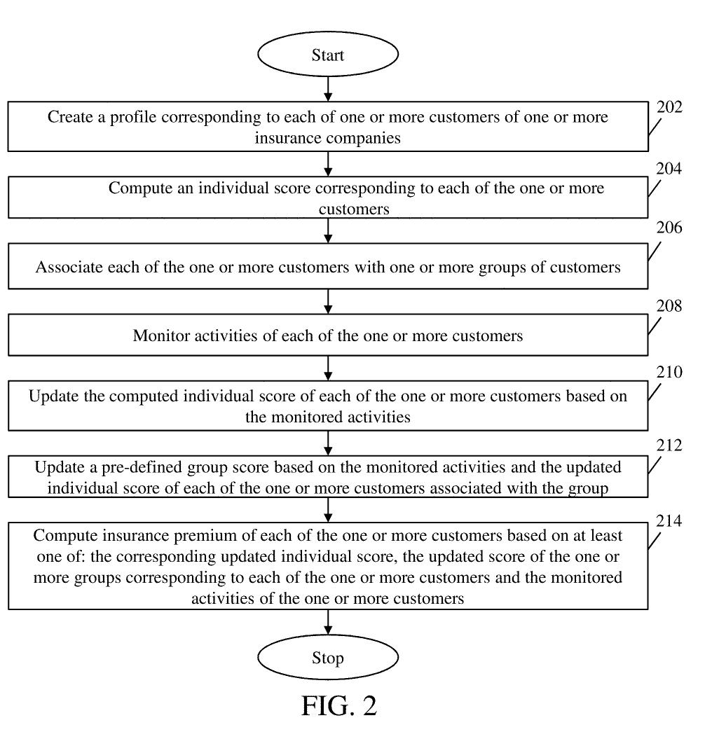

FIG. 2 is a flowchart illustrating a method for managing risk and reducing costs for insurance companies, in accordance with an embodiment of the present invention.

At step 202, a profile corresponding to each of one or more customers of one or more insurance companies is created. The one or more customers access a customer portal using one or more electronic communication devices. In the embodiment of the present invention, the one or more electronic communication devices include, but not limited to, desktops, mobile phones, laptops and tablets. On becoming a customer of the one or more insurance companies, the one or more customers access their profiles via the customer portal using the one or more electronic communication devices. Further, the one or more customers access their profile by providing authentication details including, but not limited to, login identification and password provided at the time of registration and creation of the customer profile.

In an embodiment of the present invention, profiles of the one or more customers are created automatically when they buy an insurance product from the one or more insurance companies. In another embodiment of the present invention, the customer portal provides options for creating a customer profile by prompting new customers to provide details such as, but not limited to, primary email address, secondary email address new password, name, phone number, policy number, date of birth and address for profile creation. In an embodiment of the present invention, the customer portal provides options to the one or more customers to create a new customer profile using existing accounts on one or more social media websites such as, but not limited to, Facebook, Google+ and LinkedIn. On accessing the created customer profiles, the one or more customers are provided options for, but not limited to, viewing, editing and managing profile, friends list, profiles of friends and possible connections, recent conversations, discussion threads within the one or more groups, insurance company details, list of frequently used dashboards, settings, group dashboards and alerts and notification related to, but not limited to, premiums, groups, group claims and new connections.

In an embodiment of the present invention, the customer portal also provides options to the one or more customers to view one or more profiles of possible connections present on the one or more social media websites and create one or more trusted groups using the one or more profiles of the possible connections. Further, a risk score is generated for the one or more profiles of the possible connections present on the one or more social media websites. In an embodiment of the present invention, the risk score is generated for the one or more profiles of the possible connections on the one or more social media websites prior to addition to the one or more created trusted groups.

At step 204, an individual score corresponding to each of the one or more customers is computed by a score management algorithm. In an embodiment of the present invention, the individual score corresponding to each of the one or more customers is computed based on the created customer profile and one or more parameters. In an embodiment of the present invention, each of one or more parameters used for dynamically managing individual customer score are calibrated by the one or more insurance companies. In an embodiment of the present invention, for increasing the individual score the one or more parameters considered include, but not limited to, number of referrals in low, medium and high risk categories, total number of referrals, frequency of referrals, referral fitment, number of claims, number of frauds, number of reported fraudulent activities and number of policy enrollments by a customer. In an embodiment of the present invention, the score of individual customers is decreased by considering parameters such as, but not limited to, number of wrong and fraudulently submitted claims by customers and number of times wrong information was provided by customer.

At step 206, each of the one or more customers are associated with one or more pre-defined groups of customers. In an embodiment of the present invention, one or more options related to the one or more groups are provided via the customer portal to the one or more customers. One or more employees of the one or more insurance companies are also provided options for creating groups and configuring parameters for group creation/association via a carrier portal. The one or more groups are formed and the one or more customers are associated with the one or more groups based on criteria such as, but not limited to, demographic factors, type of insurance product and risk profile of the customers.

At step 208, activities of each of the one or more customers are monitored. The monitored activities include, but not limited to, number of referrals in low, medium and high risk categories, frequency of referrals, referral fitment, number of claims, number of frauds, number of reported fraudulent activities and number of policy enrollment.

At step 210, the computed individual score of each of the one or more customers is updated based on the monitored activities by the score management algorithm.

At step 212, a pre-defined group score is updated based on the monitored activities and the updated individual score of each of the one or more customers associated with the group by the score management algorithm. In an embodiment of the present invention, each group has a group score which is a function of all the members' individual scores, group members' behavior and other group parameters such as, but not limited to, number of members, rate of increase of trusted members and the likes.

At step 214, insurance premium of each of the one or more customers is computed based on at least one of: the corresponding updated individual score, the updated score of the one or more groups corresponding to each of the one or more customers and the monitored activities of the one or more customers. In an embodiment of the present invention, one or more existing systems are facilitated to compute the insurance premium of each of the one or more customers based on at least one of: the corresponding updated individual score, the updated score of the one or more groups corresponding to each of the one or more customers and the monitored activities of the one or more customers.

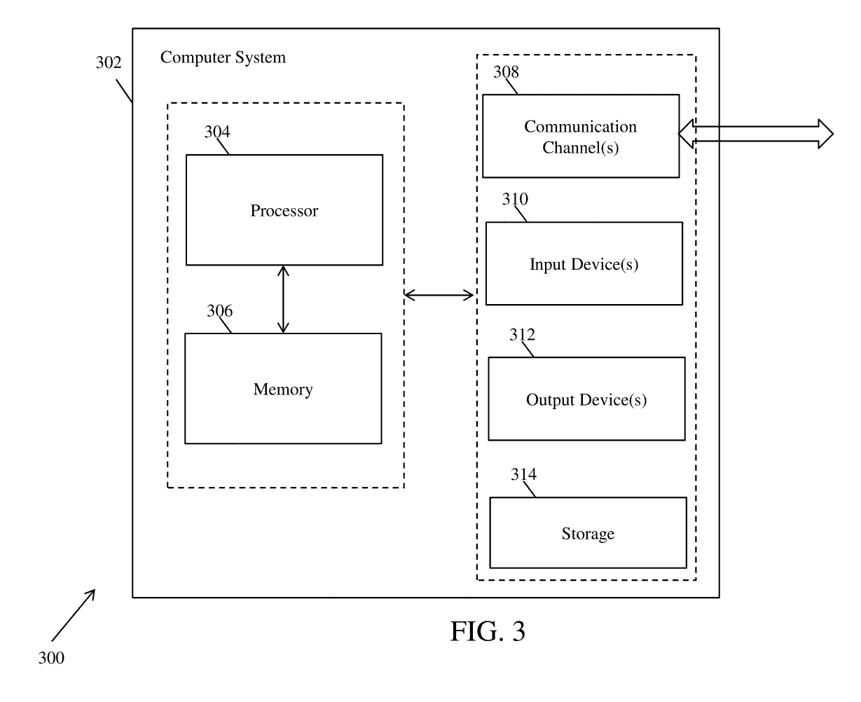

FIG. 3 illustrates an exemplary computer system for efficiently managing risks and reducing costs for insurance companies, in accordance with an embodiment of the present invention.

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A computer-implemented method for managing risks and reducing costs for insurance companies, via program instructions stored in a memory and executed by a processor, the computer-implemented method comprising:
creating a profile corresponding to each of one or more customers of one or more insurance companies;
computing an individual score corresponding to each of the one or more customers;
associating each of the one or more customers with one or more pre-defined groups of customers;
monitoring activities of each of the one or more customers;
updating the computed individual score of each of the one or more customers based on the monitored activities;
updating a pre-defined group score based on the monitored activities and the updated individual score of each of the one or more customers associated with the group; and
facilitating one or more existing systems to compute insurance premium of each of the one or more customers based on at least one of: the corresponding updated individual score, the updated score of the one or more groups corresponding to each of the one or more customers and the monitored activities of the one or more customers.

2. The computer-implemented method of claim 1, wherein the profile corresponding to each of the one or more customers of the one or more insurance companies is created by the one or more customers using existing accounts on one or more social media websites.

3. The computer-implemented method of claim 1, wherein the profile corresponding to each of the one or more customers of the one or more insurance companies is created by the one or more customers by providing details comprising primary email address, secondary email address, new password, name, phone number, policy number, address and date of birth.

4. The computer-implemented method of claim 1, wherein the individual score corresponding to each of the one or more customers is computed based on the created customer profile and one or more parameters.

5. The computer-implemented method of claim 4, wherein the one or more parameters for computing individual score comprise number of referrals in low, medium and high risk categories, total number of referrals, frequency of referrals, referral fitment, number of claims, number of frauds, number of reported fraudulent activities and number of policy enrolments by a customer.

6. The computer-implemented method of claim 1, wherein the one or more customers are associated with one or more pre-defined groups based on one or more criteria comprising demographic factors, type of insurance product and risk profile of customer.

7. The computer-implemented method of claim 1, wherein the monitored activities of each of the one or more customers comprise number of referrals in low, medium and high risk categories, frequency of referrals, referral fitment, number of claims, number of frauds, number of reported fraudulent activities and number of policy enrolments.

8. The computer-implemented method of claim 1 further comprising the step of facilitating the one or more customers to view one or more profiles of possible connections present on one or more social media websites and create one or more trusted groups.

9. The computer-implemented method of claim 8 further comprising generating a risk score for the one or more profiles of the possible connections present on the one or more social media websites.

10. A system for managing risks and reducing costs for insurance companies, the system comprising:
a customer portal configured to create a profile corresponding to each of one or more customers of one or more insurance companies;
a member management module configured to:
compute an individual score corresponding to each of the one or more customers;
associate each of the one or more customers with one or more pre-defined groups of customers;
monitor activities of each of the one or more customers; and
update the computed individual score of each of the one or more customers based on the monitored activities;
a group management module configured to update a pre-defined group score based on the monitored activities and the updated individual score of each of the one or more customers associated with the group; and
an analytical engine configured to communicate with one or more existing systems to facilitate computing insurance premium of each of the one or more customers based on at least one of: the corresponding updated individual score, the updated score of the one or more groups corresponding to each of the one or more customers and the monitored activities of the one or more customers.

11. The system of claim 10, wherein the profile corresponding to each of the one or more customers is created by the one or more customers using existing accounts on one or more social media websites.

12. The system of claim 10, wherein the profile corresponding to each of the one or more customers is created by the one or more customers by providing details comprising primary email address, secondary email address, new password, name, phone number, policy number, address and date of birth.

13. The system of claim 10, wherein the individual score corresponding to each of the one or more customers is computed based on the created customer profile and one or more parameters.

14. The system of claim 13, wherein the one or more parameters for computing individual score comprise number of referrals in low, medium and high risk categories, total number of referrals, frequency of referrals, referral fitment, number of claims, number of frauds, number of reported fraudulent activities and number of policy enrolments by a customer.

15. The system of claim 10, wherein the one or more customers are associated with one or more pre-defined groups based on one or more criteria comprising demographic factors, type of insurance product and risk profile of customer.

16. The system of claim 10, wherein the monitored activities of each of the one or more customers comprise number of referrals in low, medium and high risk categories, frequency of referrals, referral fitment, number of claims, number of frauds, number of reported fraudulent activities and number of policy enrolments.

17. The system of claim 10 further comprising a social media interface module configured to facilitate the one or more customers to view one or more profiles of possible connections present on one or more social media websites and create one or more trusted groups.

18. The system of claim 17 further comprising a risk profiling module configured to generate a risk score for the one or more profiles of the possible connections present on the one or more social media websites.

19. A computer program product for managing risks and reducing costs for insurance companies, the computer program product comprising:
a non-transitory computer-readable medium having computer-readable program code stored thereon, the computer-readable program code comprising instructions that when executed by a processor, cause the processor to:
create a profile corresponding to each of one or more customers of one or more insurance companies;
compute an individual score corresponding to each of the one or more customers;
associate each of the one or more customers with one or more pre-defined groups of customers;
monitor activities of each of the one or more customers;
update the computed individual score of each of the one or more customers based on the monitored activities;
update a pre-defined group score based on the monitored activities and the updated individual score of each of the one or more customers associated with the group; and
facilitate one or more existing systems to compute insurance premium of each of the one or more customers based on at least one of: the corresponding updated individual score, the updated score of the one or more groups corresponding to each of the one or more customers and the monitored activities of the one or more customers.
